(19) United States
(12) Patent Application Publication
(10) Pub. No.: US 2019/0062359 A1
(43) Pub. Date: Feb. 28, 2019

(54) ORGANOSOLV PROCESS FOR THE EXTRACTION OF HIGHLY PURE LIGNIN AND PRODUCTS COMPRISING THE SAME

(71) Applicant: UNIVERSITE LAVAL, Quebec (CA)

(72) Inventors: Tatjana STEVANOVIC, Quebec (CA); Georges KOUMBA YOYA, Quebec (CA)

(73) Assignee: UNIVERSITE LAVAL, Quebec, QC (CA)

(21) Appl. No.: 15/577,353

(22) PCT Filed: Jun. 9, 2016
(86) PCT No.: PCT/CA2016/000169

§ 371 Date: Nov. 28, 2017

Related U.S. Application Data
(60) Provisional application No. 62/173,202, filed on Jun. 9, 2015.

(51) Int. Cl. C07G 1/00; D21C 3/04; D21C 3/20; D21C 11/00

(52) U.S. Cl. CPC C07G 1/00; D21C 11/0007; D21C 3/20; D21C 3/04

(57) ABSTRACT

A highly pure lignin comprising a lignin content of at least 97% and characterized by a low carbohydrate content and substantially no sulfur content is disclosed herein. An organosolv process for extracting the highly pure lignin is also disclosed herein. The process comprises pretreating a lignocellulosic material in a first polar protic solvent, to remove extractive compounds and to provide a pretreated lignocellulosic material; and treating the pretreated lignocellulosic material with a Lewis acid in a second polar protic solvent.

### CROSS REFERENCE TO RELATED APPLICATIONS

This application is a national phase application under 35 U.S.C. § 371 of International Application No. PCT/CA2016/000169, filed Jun. 9, 2016, which claims the benefit of U.S. Provisional Application No. 62/173,202, filed Jun. 9, 2015. The contents of the referenced applications are incorporated into the present application by reference.

### FIELD

The present disclosure broadly relates to a process for treatment of biomass. More specifically, but not exclusively, the present disclosure relates to an organosolv process for the extraction of highly pure lignin from biomass. The present disclosure also relates to a highly pure lignin as well as products and compositions comprising same.

### BACKGROUND

With the reduction in petroleum reserves and the increase in greenhouse gas emissions, there is a constantly growing interest in the production and use of alternative, non-fossil green fuels and chemicals. The valorization of lignocellulosic biomass is especially attractive. The organosolv processes are interesting because they provide lignin of higher purity than other industrial processes. Moreover, the lignin so obtained can also be readily functionalized. Furthermore, organosolv lignin contains less ash and carbohydrate residues than other types of industrial lignin (i.e. lignosulfonate, soda or kraft lignin).

The recovery of lignin is difficult to control because extraction processes implemented to isolate lignin typically end up destroying the primary structure in its native form. In fact, to understand the molecular structure of lignin, models of lignin such as dimers of the β-O-4 type are elaborated and commonly used to study the process of degradation of lignin, such as by microbial degradation.

Basidiomycetes, from white rot fungi, are known to degrade wood in its natural environment. Generally, the lignin extraction from lignocellulosic materials is carried out under conditions in which lignin is gradually but strongly degraded by fragmentation, to lead to the release of lower average molecular weight fragments, resulting in several changes of the physico-chemical properties of lignin.

Currently, most of the available lignin comes from the black liquor of four major delignification processes: 1—Kraft process (i.e., sulfate pulping with Na₂S and NaOH); 2—Soda process, which takes place in alkali conditions using NaOH; 3—Sulfite pulping (i.e., with NaHSO₃ or NH4SO₃H etc.); and 4—Organosolv process, with organic solvent(s) which usually takes place under acidic conditions at pH≤4.

Kraft lignins and lignosulfonates, represent the more important volumes of production in terms of tonnage. The sulfate or Kraft process represents by itself the most widely used process for pulp production, and hence for lignin recovery, which remains limited due to the recovery technology of the Kraft process. Despite a production in excess of 85% of all lignins, the high levels of carbohydrates, ash and sulfur in Kraft lignins and lignosulfonates, seriously limit their applications.

The organosolv lignin extraction process typically consists in solubilizing and extracting lignin and hemicellulose in an organic solvent, typically methanol or ethanol, leaving behind insoluble solid cellulose fibers. An acid catalyst, such as HCl, H₂SO₄, acetic acid, formic acid, and the like, is often added when the extraction temperature is lower than 180° C. The organic solvent is then recycled through evaporation.

Timilsena et al. (Timilsena, Y. P.; Audu, I. G.; Rakshi, S. K.; Brosse, N. Biomass and bioenergy 52 (2013) 151-158) have performed the Miscanthus pre-treatment with 2-naphthol and other aromatic compounds as carbonium ion scavengers, followed by an organosolv treatment with sulfuric acid as the acid catalyst. Timilsena et al. concluded that the organosolv delignification enhancement, due to the addition of 2-naphthol in hydrothermal processing, showed comparable ability to that of p-cresol and anthraquinone derivatives.

Jesús de la Torre et al. (Jesús de la Torre.; Moral, A.; Hernandez, D.; Cabeza, E.; Tijero, A. Industrial Crops and Products 45 (2013) 58-63) have performed the ethanol organosolv lignin extraction from wheat straw as the raw material and using different catalysts such as hydrochloric acid, sulfuric acid, nitric acid, orthophosphoric acid, formic glacial acetic acid, oxalic acid 2-hydrate, anhydrous calcium chloride, anhydrous aluminum chloride and anhydrous Iron (III) chloride. The authors concluded that the organosolv delignification provided better results when hydrochloric acid was used as the catalyst.

Schwiderski et al. (Schwiderski, M.; Kruse, A.; Grandl, R.; Dockendorf, D. Green Chem., 2014, 16, 1569-1578) have performed the ethanol organosolv lignin isolation process from beech wood as the raw material and using HCl or AlCl₃ as the catalyst. According to the authors, the best results were obtained when using AlCl₃ which however led to isolation of lignins with lower Mn and Mw values.

Wang et al. (Wang, K.; Yang, H.; Guo, S.; Yao, X.; Sun, R-C. J. Appl. Polym. Sci. 2014, 39673) have performed the triploid poplar pretreatment with ethanol-toluene extraction followed by an organosolv treatment using formic acid, trimethylamine or sodium hydroxide as the catalyst with the aim of improving bioconversion during a saccharification and fermentation process. According to the authors, the best results were obtained with NaOH as the catalyst.

Organic solvents are typically required to perform the organosolv process for separating wood components. Several organosolv processes such as the Organocell (i.e. sodium hydroxide and methanol/water), Acetosolv or Alcell (i.e. acetic acid, acetone and ethanol/water), Lignol (i.e. sulfuric acid and ethanol/water respectively) and Formacell or CIMV lignin (acetic/formic acid and water) have been operated at full or pilot scale.

Plant secondary metabolites are produced during the phase following primary plant growth. They are therefore not essential for their growth. These metabolites have a wide range of chemical structures such as terpenoids, sugars, alkaloids and polyphenolic compounds. Polyphenolic compounds contain a large variety of complex aromatic structures. Most of these compounds are derived from the phenylpropanoid metabolism shared with lignins.

Since much of the delignification processes are based on the principle of a redox reaction, which implicates both free hydroxyls and ether linkages of the substructures, it would be advantageous to eliminate some metabolites that could potentially enter into competition with lignin interacting with a specific catalyst, prior to treatment with the catalyst. Under these circumstances, a plant material free of these metabolites, would allow for better catalytic performances during delignification. Soxhlet extraction remains one of the most common methods for the elimination of these metabolites. In addition to the simplicity of the Soxhlet extraction, it also has the advantage of preserving the macromolecular components of the wood source intact.

The present disclosure refers to a number of documents, the contents of which are herein incorporated by reference in their entirety.

### SUMMARY

In an aspect, the present disclosure broadly relates to a process for treatment of biomass. More specifically, but not exclusively, the present disclosure relates to an organosolv process for the extraction of highly pure lignin from biomass. The present disclosure also relates to a purified lignin as well as products and compositions comprising same.

In an aspect, the present disclosure relates to organosolv lignins comprising low carbohydrate content and substantially no sulfur content.

In an aspect, the present disclosure relates to an organosolv process for extracting lignin from a lignocellulosic material, the process comprising: pretreating the lignocellulosic material in a first polar protic solvent, to remove extractive compounds and to provide a pretreated lignocellulosic material; and treating the pretreated lignocellulosic material with a Lewis acid in a second polar protic solvent, to provide a highly pure lignin. In an embodiment of the present disclosure, the first polar protic solvent is a mixture of ethanol and water.

In an aspect, the present disclosure relates to an organosolv process for extracting lignin from a lignocellulosic material, the process comprising: pretreating the lignocellulosic material in a first polar protic solvent, to remove extractive compounds and to provide a pretreated lignocellulosic material; and treating the pretreated lignocellulosic material with a Lewis acid in a second polar protic solvent, to provide a highly pure lignin. In an embodiment of the present disclosure, the first polar protic solvent is a mixture of ethanol and water. In a further embodiment of the present disclosure, the second polar protic solvent is a mixture of ethanol and water.

In an aspect, the present disclosure relates to an organosolv process for extracting lignin from a lignocellulosic material, the process comprising: pretreating the lignocellulosic material in a first polar protic solvent, to remove extractive compounds and to provide a pretreated lignocellulosic material; and treating the pretreated lignocellulosic material with a Lewis acid in a second polar protic solvent, to provide a highly pure lignin. In an embodiment of the present disclosure, the Lewis acid is at least one of Cu²⁺, Fe²⁺, Fe²⁺, Al²⁺, Ga³⁺, BF₃, Bi³⁺, Sc³⁺, La³⁺, Yb³⁺ or In³⁺ or combinations of any thereof.

In an aspect, the present disclosure relates to an organosolv process for extracting lignin from a lignocellulosic material, the process comprising: pretreating the lignocellulosic material in a first polar protic solvent, to remove extractive compounds and to provide a pretreated lignocellulosic material; and treating the pretreated lignocellulosic material with a Lewis acid in a second polar protic solvent, to provide a highly pure lignin. In an embodiment of the present disclosure, the Lewis acid is Fe³⁺.

In an aspect, the present disclosure relates to an organosolv process for extracting lignin from a lignocellulosic material, the process comprising: pretreating the lignocellulosic material in a first polar protic solvent to remove extractive polyphenolic compounds and to provide a pretreated lignocellulosic material; and treating the pretreated lignocellulosic material with a Lewis acid in a second polar protic solvent, to provide a highly pure lignin. In an embodiment of the present disclosure, the first polar protic solvent is a mixture of ethanol and water.

In an aspect, the present disclosure relates to an organosolv process for extracting lignin from a lignocellulosic material, the process comprising: pretreating the lignocellulosic material in a first polar protic solvent, to remove extractive polyphenolic compounds and to provide a pretreated lignocellulosic material; and treating the pretreated lignocellulosic material with a Lewis acid in a second polar protic solvent, to provide a highly pure lignin. In an embodiment of the present disclosure, the first polar protic solvent is a mixture of ethanol and water. In a further embodiment of the present disclosure, the second polar protic solvent is a mixture of ethanol and water.

In an aspect, the present disclosure relates to an organosolv process for extracting lignin from a lignocellulosic material, the process comprising: pretreating the lignocellulosic material in a first polar protic solvent, to remove extractive polyphenolic compounds and to provide a pretreated lignocellulosic material; and treating the pretreated lignocellulosic material with a Lewis acid in a second polar protic solvent, to provide a highly pure lignin. In an embodiment of the present disclosure, the Lewis acid is at least one of Cu³⁺, Fe³⁺, Fe³⁺, Al³⁺, Ga³⁺, BF₃, Bi³⁺, Sc³⁺, La³⁺, Yb³⁺ or In³⁺ or combinations of any thereof.

In an aspect, the present disclosure relates to an organosolv process for extracting lignin from a lignocellulosic material, the process comprising: pretreating the lignocellulosic material in a first polar protic solvent, to remove extractive polyphenolic compounds and to provide a pretreated lignocellulosic material; and treating the pretreated lignocellulosic material with a Lewis acid in a second polar protic solvent, to provide a highly pure lignin. In an embodiment of the present disclosure, the Lewis acid is Fe³⁺.

In an aspect, the present disclosure relates to a highly pure lignin comprising a lignin content ranging from about 97% to about 99.9%.

In an aspect, the present disclosure relates to a highly pure lignin comprising a lignin content ranging from about 97% to about 99.9%. In an embodiment of the present disclosure, the highly pure lignin is characterized by a low carbohydrate content.

In an aspect, the present disclosure relates to a highly pure lignin comprising a lignin content ranging from about 97% to about 99.9%. In an embodiment of the present disclosure, the highly pure lignin is characterized by a low carbohydrate content. In a further embodiment of the present disclosure, the carbohydrate content is less than about 1%.

In an aspect, the present disclosure relates to a highly pure lignin comprising a lignin content ranging from about 97% to about 99.9%. In an embodiment of the present disclosure, the highly pure lignin is characterized by substantially no sulfur content.

In an aspect, the present disclosure relates to a highly pure lignin comprising a lignin content ranging from about 97% to about 99.9%. In an embodiment of the present disclosure, the highly pure lignin is characterized by a low carbohydrate content. In a further embodiment, the highly pure lignin is characterized by substantially no sulfur content.

In an aspect, the present disclosure relates to a highly pure lignin comprising a lignin content ranging from about 97% to about 99.9%. In an embodiment of the present disclosure, the highly pure lignin is characterized by a low carbohydrate content. In a further embodiment, the highly pure lignin is characterized by substantially no sulfur content. In a further embodiment of the present disclosure, the carbohydrate content is less than about 1%.

In an aspect, the present disclosure relates to a highly pure lignin comprising a lignin content ranging from about 97% to about 99.9%. In an embodiment of the present disclosure, the highly pure lignin is characterized by a low carbohydrate content and substantially no sulfur content.

In an aspect, the present disclosure relates to a highly pure lignin comprising a lignin content ranging from about 97% to about 99.9%. In an embodiment of the present disclosure, the highly pure lignin is characterized by a low carbohydrate content and substantially no sulfur content. In a further embodiment of the present disclosure, the carbohydrate content is less than about 1%.

In an aspect, the present disclosure relates to a highly pure lignin comprising a lignin content ranging from about 97% to about 99.9%. In an embodiment of the present disclosure, the highly pure lignin is characterized by a volatile organic content (VOC) of less than about 5%.

In an aspect, the present disclosure relates to a highly pure lignin comprising a lignin content ranging from about 97% to about 99.9%. In an embodiment of the present disclosure, the highly pure lignin is characterized by a volatile organic content (VOC) of less than about 5%. In an embodiment of the present disclosure, the highly pure lignin is characterized by a low carbohydrate content.

In an aspect, the present disclosure relates to a highly pure lignin comprising a lignin content ranging from about 97% to about 99.9%. In an embodiment of the present disclosure, the highly pure lignin is characterized by a volatile organic content (VOC) of less than about 5%. In a further embodiment of the present disclosure, the highly pure lignin is characterized by a low carbohydrate content. In a further embodiment, the highly pure lignin is characterized by substantially no sulfur content.

In an aspect, the present disclosure relates to a highly pure lignin comprising a lignin content ranging from about 97% to about 99.9%. In an embodiment of the present disclosure, the highly pure lignin is characterized by a volatile organic content (VOC) of less than about 5%. In a further embodiment of the present disclosure, the highly pure lignin is characterized by a low carbohydrate content. In a further embodiment of the present disclosure, the carbohydrate content is less than about 1%. In a further embodiment, the highly pure lignin is characterized by substantially no sulfur content.

In an aspect, the present disclosure relates to a highly pure lignin comprising a lignin content ranging from about 97% to about 99.9%. In an embodiment of the present disclosure, the highly pure lignin is characterized by a low carbohydrate content, substantially no sulfur content and volatile organic content (VOC) of less than about 5%.

In an aspect, the present disclosure relates to a highly pure lignin comprising a lignin content ranging from about 97% to about 99.9%. In an embodiment of the present disclosure, the highly pure lignin is characterized by a low carbohydrate content, substantially no sulfur content and volatile organic content (VOC) of less than about 5%. In a further embodiment of the present disclosure, the carbohydrate content is less than about 1%.

Also disclosed in the context of the present disclosure are embodiments 1 to 43. Embodiment 1 is an organosolv process for extracting highly pure lignin from a lignocellulosic material, the process comprising: pretreating the lignocellulosic material in a first polar protic solvent, to remove extractive compounds and to provide a pretreated lignocellulosic material; and treating the pretreated lignocellulosic material with a Lewis acid in a second polar protic solvent, to provide a highly pure lignin. Embodiment 2 is the process of embodiment 1, wherein the first polar protic solvent is at least one of CH₃COOH, HCOOH, H₂O, CH₃OH, EtOH, iPrOH, PrOH, BuOH, iBuOH or tBuOH or combinations of any thereof. Embodiment 3 is the process of embodiment 1 or 2, wherein the second polar protic solvent is at least one of CH₃COOH, HCOOH, H₂O, CH₃OH, EtOH, iPrOH, PrOH, BuOH, iBuOH or tBuOH or combinations of any thereof. Embodiment 4 is the process of embodiment 3, wherein the first polar protic solvent is a mixture of polar protic solvents. Embodiment 5 is the process of embodiment 4, wherein the mixture of polar protic solvents includes a ratio of about 1:10 to about 10:1 of two polar protic solvents. Embodiment 6 is the process of embodiment 5, wherein the mixture of polar protic solvents includes a ratio of 1:1 of the two polar protic solvents. Embodiment 7 is the process of any one of embodiments 4 to 6, wherein the first polar protic solvent is a mixture of ethanol and water. Embodiment 8 is the process of any one of embodiments 3 to 7, wherein the second polar protic solvent is a mixture of polar protic solvents. Embodiment 9 is the process of embodiment 8, wherein the mixture of polar protic solvents includes a ratio of about 1:10 to about 10:1 of two polar protic solvents. Embodiment 10 is the process of embodiment 9, wherein the mixture of polar protic solvents includes a ratio of 1:1 of the two polar protic solvents. Embodiment 11 is the process of any one of embodiments 8 to 10, wherein the second polar protic solvent is a mixture of ethanol and water. Embodiment 12 is the process of any one of embodiments 1 to 11, wherein the Lewis acid is at least one of Cu²⁺, Fe²⁺, Fe³⁺, Al³⁺, Ga³⁺, BF₃, Bi³⁺, Sc³⁺, La³⁺, Yb³⁺ or In³⁺ or combinations of any thereof. Embodiment 13 is the process of any one of embodiments 1 to 12, wherein the Lewis acid is Fe³⁺. Embodiment 14 is the process of any one of embodiments 1 to 13, wherein the pretreating the lignocellulosic material is performed at a temperature ranging from about 60° C. to about 100° C. Embodiment 15 is the process of any one of embodiments 1 to 14, wherein the treating the pretreated lignocellulosic material comprises precipitating the treated lignocellulosic material under acidic conditions. Embodiment 16 is the process of embodiment 15, wherein the precipitating is performed at a pH ranging from about 0.3 to about 4.0. Embodiment 17 is the process of embodiment 16, wherein the precipitating is performed at a pH ranging from about 1.0 to about 2.5. Embodiment 18 is the process of any one of embodiments 1 to 17, wherein the lignocellulosic material is at least one of herbaceous biomass, softwood, hardwood or combinations thereof.

Embodiment 19 is a highly pure lignin comprising a lignin content of at least 97%. Embodiment 20 is the highly pure lignin of embodiment 19, wherein the highly pure lignin comprises a lignin content ranging from about 97% to about 99.9%. Embodiment 21 is the highly pure lignin of embodiment 19 or 20, wherein the highly pure lignin is characterized by a low carbohydrate content. Embodiment 22 is the highly pure lignin of embodiment 21, wherein the carbohydrate content is less than about 1%. Embodiment 23 is the highly pure lignin of any one of embodiments 19 to 22, wherein the highly pure lignin is further characterized by a low ash content. Embodiment 24 is the highly pure lignin of any one of embodiments 19 to 23, wherein the highly pure lignin is further characterized by substantially no sulfur content. Embodiment 25 is the highly pure lignin of any one of embodiments 19 to 24, wherein the highly pure lignin is further characterized by a volatile organic content (VOC) of less than about 5%. Embodiment 26 is the highly pure lignin of any one of embodiments 19 to 25, wherein the highly pure lignin is further characterized by a phenolic OH content of at least 4.00 mmol/g.

Embodiment 27 is a use of an organosolv process for the separation of a highly pure lignin from a lignocellulosic material, wherein the highly pure lignin comprises a lignin content of at least 97%. Embodiment 28 is the use of embodiment 27, wherein the highly pure lignin comprises a lignin content ranging from about 97% to about 99.9%. Embodiment 29 is the use of embodiment 27 or 28, wherein the highly pure lignin is characterized by a low carbohydrate content. Embodiment 30 is the use of embodiment 29, wherein the carbohydrate content is less than about 1%. Embodiment 31 is the use of any one of embodiments 27 to 30, wherein the highly pure lignin is further characterized by substantially no sulfur content. Embodiment 32 is the use of any one of embodiments 27 to 31, wherein the highly pure lignin is further characterized by a volatile organic content (VOC) of less than about 5%. Embodiment 33 is the use of any one of embodiments 27 to 32, wherein the highly pure lignin is further characterized by a phenolic OH content of at least 4.00 mmol/g. Embodiment 34 is the use of any one of embodiments 27 to 33, wherein the organosolv process comprises: pretreating the lignocellulosic material in a first polar protic solvent, to remove extractive compounds and to provide a pretreated lignocellulosic material; and treating the pretreated lignocellulosic material with a Lewis acid in a second polar protic solvent, to provide a highly pure lignin. Embodiment 35 is the use of embodiment 34, wherein the first polar protic solvent is at least one of CH₃COOH, HCOOH, H₂O, CH₃OH, EtOH, iPrOH, PrOH, BuOH, iBuOH or tBuOH or combinations of any thereof. Embodiment 36 is the use of embodiment 34 or 35, wherein the second polar protic solvent is at least one of CH₃COOH, HCOOH, H₂O, CH₃OH, EtOH, iPrOH, PrOH, BuOH, iBuOH or tBuOH or combinations of any thereof. Embodiment 37 is the use of any one of embodiments 34 to 36, wherein the Lewis acid is at least one of Cu²⁺, Fe²⁺, Fe³⁺, Al³⁺, Ga³⁺, BF₃, Bi³⁺, Sc³⁺, La³⁺, Yb³⁺ or In³⁺ or combinations of any thereof. Embodiment 38 is the use of any one of embodiments 34 to 37, wherein the Lewis acid is Fe³⁺. Embodiment 39 is the use of any one of embodiments 34 to 38, wherein the pretreating the lignocellulosic material is performed at a temperature ranging from about 60° C. to about 100° C. Embodiment 40 is the use of any one of embodiments 34 to 39, wherein the treating the pretreated lignocellulosic material comprises precipitating the treated lignocellulosic material under acidic conditions. Embodiment 41 is the use of embodiment 40, wherein the precipitating is performed at a pH ranging from about 0.3 to about 4.0. Embodiment 42 is the use of embodiment 41, wherein the precipitating is performed at a pH ranging from about 1.0 to about 2.5. Embodiment 43 is the use of any one of embodiments 34 to 42, wherein the lignocellulosic material is at least one of herbaceous biomass, softwood, hardwood or combinations thereof.

The foregoing and other advantages and features of the present disclosure will become more apparent upon reading of the following non-restrictive description of illustrative embodiments thereof, given by way of example only with reference to the accompanying drawings/figures.

### BRIEF DESCRIPTION OF THE DRAWINGS/FIGURES

In the appended drawings/figures:

FIG. 1 illustrates a schematic diagram of an organosolv process for the extraction of a highly pure lignin from a lignocellulosic material, in accordance with an embodiment of the present disclosure.

FIG. 2 illustrates lignin peroxidase.

FIG. 3 illustrates an organosolv process for the extraction of a highly pure lignin from an Aspen wood material in accordance with Example 1 of the present disclosure.

FIG. 4 illustrates the results of FT-IR analyses, showing lignin spectra at different steps of the organosolv process in accordance with various embodiments (e.g. without catalyst or without pretreatment) of the present disclosure.

FIG. 5 illustrates the results of FT-IR analyses of lignins obtained using various organosolv processes (e.g. Alcell lignin and Lignol lignin) as well as highly pure Lifer lignin obtained using the organosolv process in accordance with an embodiment of the present disclosure.

FIG. 6 illustrates ³¹P NMR analyses of lignin obtained using various organosolv processes (e.g. Alcell lignin and Lignol lignin) as well as highly pure Lifer lignin obtained using the organosolv process in accordance with an embodiment of the present disclosure.

FIG. 7 illustrates results obtained with Lifer lignin using 2D NMR HSQC experiments, in accordance with an embodiment of the present disclosure.

FIG. 8 illustrates the level of lignin condensation predicted with Py-GC/MS analysis for different lignins obtained using various organosolv processes (e.g. Alcell lignin and Lignol lignin) as well as highly pure Lifer lignin obtained using the organosolv process in accordance with an embodiment of the present disclosure.

FIG. 9 illustrates TGA results under nitrogen from 25° C. to 800° C. at 5° C./min obtained for different lignins obtained using various organosolv processes (e.g. Alcell lignin and Lignol lignin) as well as highly pure Lifer lignin obtained using the organosolv process in accordance with an embodiment of the present disclosure.

FIG. 10 illustrates lignin nanofibers obtained using the organosolv process in accordance with an embodiment of the present disclosure.

### DETAILED DESCRIPTION

### Glossary

In order to provide a clear and consistent understanding of the terms used in the present disclosure, a number of definitions are provided below. Moreover, unless defined otherwise, all technical and scientific terms as used herein have the same meaning as commonly understood by one of ordinary skill in the art to which this disclosure pertains.

The word “a” or “an” when used in conjunction with the term “comprising” in the claims and/or the disclosure may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

As used in this disclosure and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used in this disclosure and claim(s), the word “consisting” and its derivatives, are intended to be close ended terms that specify the presence of stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The terms “about”, “substantially” and “approximately” as used herein mean a reasonable amount of deviation of the modified term such that the end result is not significantly changed. These terms of degree should be construed as including a deviation of at least ±1% of the modified term if this deviation would not negate the meaning of the word it modifies.

The term “substantially” when used in a negative connotation to refer to the complete or near complete lack of sulfur in the highly pure lignin means that the highly pure lignin would either completely lack sulfur content or so nearly completely lack sulfur content that the effect would be the same as if it completely lacked sulfur content. In other words, a highly pure lignin that is “substantially free of sulfur content” may still actually have sulfur content as long as there is no measurable effect thereof.

As used herein, the term “Lewis acid” refers to an electron pair acceptor.

The term “volatile organic compounds” (VOC) as used herein, refers to any organic (i.e. carbon-based) chemical compounds that have high enough vapor pressures under normal processing conditions, such as encountered in the processes of the present disclosure, to significantly vaporize and to enter the atmosphere. Accordingly, as used herein, it is not necessarily required that a particular VOC according to the present disclosure is fully vaporized under the environmental conditions employed and/or is only present in gaseous (volatile) form. Rather, at least part of a VOC according to the present disclosure may also be present in another aggregate state, for example in liquid form.

The term “lignin” as used herein, refers to a complex high molecular weight polymer found in woody plants, trees, and agricultural crops. Any plant source (e.g., hardwood lignin, softwood lignin, grass lignin, straw lignin, and bamboo lignin), nut source (e.g., pecan shell, walnut shell, peanut shell, etc. as a fine powder), seed source (e.g., cotton seed shell as a fine powder), and the like can be used as a source of lignins suitable for use in the process of the present disclosure.

The term “extractives” as used herein, refers to biomass constituents and/or metabolites that are extracted during the pretreatment of biomass in accordance with an embodiment of the present disclosure. Non-limiting examples include polyphenols, phenolic glycosides, alkaloids and terpenoids. Further non-limiting examples include bioactive compounds.

In an aspect, the present disclosure relates to an organosolv process for extracting highly pure lignin from biomass. In a further aspect, the present disclosure relates to an organosolv process for extracting highly pure lignin from lignocellulosic material. In yet a further aspect, the present disclosure relates to a highly pure lignin as well as products and compositions comprising same.

In an aspect, the present disclosure relates to an organosolv process for extracting lignin from a lignocellulosic material, the process comprising:
pretreating the lignocellulosic material in a first polar protic solvent, to remove extractive compounds and to provide a pretreated lignocellulosic material; and
treating the pretreated lignocellulosic material with a Lewis acid in a second polar protic solvent, to provide a highly pure lignin.

In an embodiment of the present disclosure, the Lewis acid is at least one of Cu²⁺, Fe²⁺, Fe³⁺, Al³⁺, Ga³⁺, BF₃, Bi³⁺, Sc³⁺, La³⁺, Yb³⁺ or In³⁺ or combinations of any thereof. In a further embodiment of the present disclosure, the first and/or second polar protic solvent is at least one of CH₃COOH, HCOOH, H₂O, CH₃OH, EtOH, iPrOH, PrOH, BuOH, iBuOH or tBuOH or combinations of any thereof. In a further embodiment of the present disclosure, the first polar protic solvent is a mixture of ethanol and water. In a further embodiment of the present disclosure, the second polar protic solvent is a mixture of ethanol and water.

In an aspect, the present disclosure relates to an organosolv process for extracting lignin from a lignocellulosic material, the process comprising:
pretreating the lignocellulosic material in a first polar protic solvent, to remove extractive polyphenolic compounds and to provide a pretreated lignocellulosic material; and
treating the pretreated lignocellulosic material with a Lewis acid in a second polar protic solvent, to provide a highly pure lignin.

In an embodiment of the present disclosure, the Lewis acid is at least one of Cu²⁺, Fe²⁺, Fe³⁺, Al³⁺, Ga³⁺, BF₃, Bi³⁺, Sc³⁺, La³⁺, Yb³⁺ or In⁺ or combinations of any thereof. In a further embodiment of the present disclosure, the first and/or second polar protic solvent is at least one of CH₃COOH, HCOOH, H₂O, CH₃OH, EtOH, iPrOH, PrOH, BuOH, iBuOH or tBuOH or combinations of any thereof. In a further embodiment of the present disclosure, the first polar protic solvent is a mixture of ethanol and water. In a further embodiment of the present disclosure, the second polar protic solvent is a mixture of ethanol and water.

In an embodiment of the present disclosure, the first and/or second polar protic solvent is a mixture of polar protic solvents. In a further embodiment of the present disclosure, the first and/or second polar protic solvent is a mixture of two polar protic solvents. In yet a further embodiment of the present disclosure, the mixture includes a ratio of about 1:10 to about 10:1 of the two polar protic solvents. In yet a further embodiment of the present disclosure, the mixture includes a ratio of about 1:1 of the two polar protic solvents. In yet a further embodiment of the present disclosure, the mixture of the two polar protic solvents includes ethanol and water.

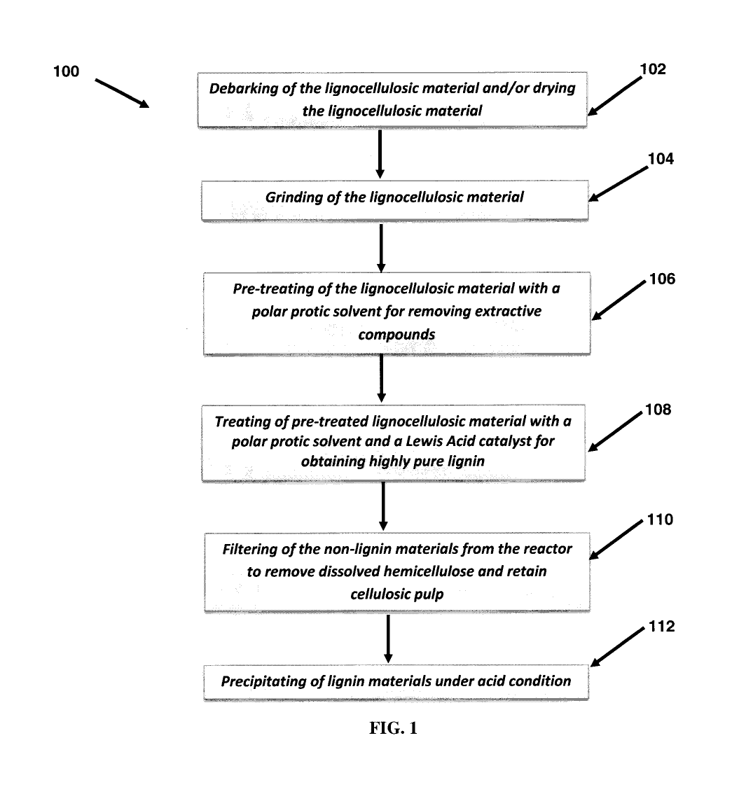

In accordance with an embodiment of the present disclosure, and with reference to FIG. 1, there is shown an organosolv process 100 for the extraction of a highly pure lignin from a lignocellulosic material. The lignocellulosic material comprises extractive compounds, non-limiting examples of which include polyphenolic/phenolic compounds. The process 100 includes step 106 of pretreating the lignocellulosic material in a first polar protic solvent to remove the extractive polyphenolic/phenolic compounds. In a further embodiment of the present disclosure, step 106 of pretreating also removes additional extractive compounds such as but not limited to terpenoids, sugars, etc. The pretreatment of the lignocellulosic material may be performed by solvent extraction, non-limiting examples of which include refluxing or Soxhlet extraction. In an embodiment of the present disclosure, the solvent extraction is performed at temperatures ranging from about 60° C. to about 100° C. In a further embodiment of the present disclosure, the pretreatment is performed for about 4 h to about 7 h. In yet a further embodiment of the present disclosure, the pretreatment is performed for about 6 h. It is to be understood that all process/method steps described herein are to be conducted under conditions sufficient to provide the desired end product (i.e. highly pure lignin). A person skilled in the art would understand that all processing conditions, including, for example, processing time, processing temperature, and whether or not the process should be performed under an anhydrous or inert atmosphere, can be varied to optimize the yield of the desired product and it is within their skill to do so.

Further, with reference to FIG. 1, process 100 includes step 108 of treating the pretreated lignocellulosic material with a Lewis Acid in a second polar protic solvent to provide highly pure lignin, following its isolation from the reaction mixture. In an embodiment of the present disclosure, the Lewis Acid is at least one of Cu²⁺, Fe²⁺, Fe³⁺, Al³⁺, Ga³⁺, BF₃, Bi³⁺, Sc³⁺, La³⁺, Yb³⁺ or In³⁺ or combinations of any thereof. In a further embodiment of the present disclosure, the Lewis acid is FeCl₃.

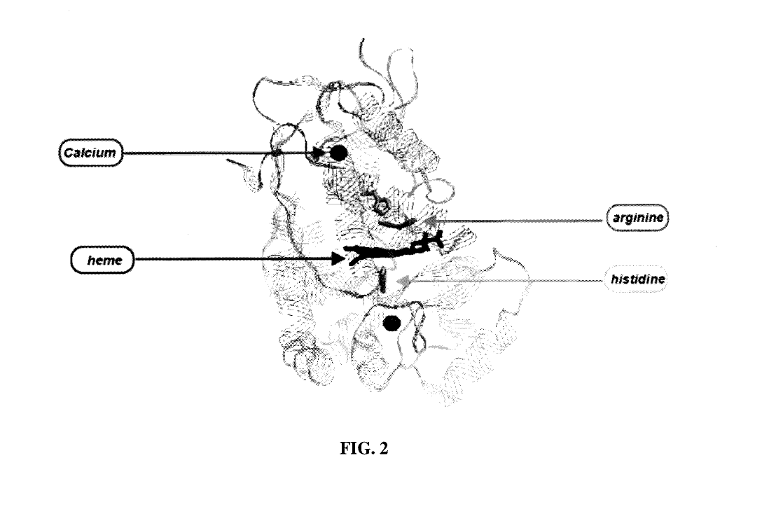

In nature, under conditions below 50° C., peroxidases are capable of oxidizing substrates such as phenols and anilines as well as a variety of other non-phenolic lignin subunits (Kirk, T. K. & Farrell, R. L. Enzymatic Combustion—the Microbial-Degradation of Lignin. Annual Review of Microbiology 1987, 41, 465-505). Lignin peroxidase (FIG. 2) contains eight cysteine residues forming disulfide bridges (Dashtban, M., Schraft, H., Syed, T. A., Qin, W. Int J Biochem Mol Biol. 2010, 1, 36-50). The iron atom of the heme group of lignin peroxidase ensures the coordinate bonding between histidine residues, stabilized by hydrogen bonding. Thus, during the enzymatic activity of lignin peroxidase in the presence of H₂O₂ or Manganese (for manganese peroxydase), the iron from the heme site evolves from Fe(III) to Fe(IV) (Dashtban, M., Schraft, H., Syed, T. A., Qin, W. Int J Biochem Mol Biol. 2010, 1, 36-50).

By analogy with these peroxidases, Lewis acids, a non-limiting example of which includes Fe(III), have been selected to mimic the catalytic activity of these enzymes. The Lewis acid will complex the phenolic compounds. Indeed, the Fe(III) species allows for complexation with the phenolic compounds while Fe(IV) allows for oxidative coupling by radical polymerization. This Lewis acid catalyst thus has the dual function of catalyzing the delignification by cleavage of the glycosidic bonds of the hemicellulose chain and cleavage of ester and ether bonds between hemicellulose and lignin, while protecting the phenols of lignin by complexation to limit condensation reactions of oxidative couplings.

According to an embodiment of the present disclosure, the catalytic treatment may be performed in a suitable reactor, such as a Parr™ reactor, at an appropriate temperature ranging from about 160° C. to about 180° C. In a further embodiment of the present disclosure, the temperature is about 170° C. It is to be understood that all process/method steps described herein are to be conducted under conditions sufficient to provide the desired end product (i.e. highly pure lignin). A person skilled in the art would understand that all processing conditions, including, for example, processing time, processing temperature, and whether or not the process should be performed under an anhydrous or inert atmosphere, can be varied to optimize the yield of the desired product and it is within their skill to do so.

The lignocellulosic material may include any wood material such as, and without limitation, an aspen wood material (i.e. Populus tremuloides Michx), or any other suitable wood material. The lignocellulosic material may be in the form of wood powder, wood fragments, wood particles and the like.

Further, with reference to FIG. 1, process 100 may further include step 102 of debarking the lignocellulosic material and/or air drying the lignocellulosic material. Yet furthermore, process 100 may include step 104 of grinding the lignocellulosic material. Following the grinding step, the ground material may be partitioned using any suitable filter system. The composition of the lignocellulosic material, prior to step 106, may include, without limitation, ethanol/water extractives (i.e., maceration), lignin, acid soluble lignin, glucose, xylose, arabinose, and the like.

Further, with reference to FIG. 1, process 100 may further include step 110 of filtering the non-lignin materials obtained from the reactor to remove dissolved hemicellulose and to obtain solid cellulosic pulp residues. The cellulose residues, may subsequently be used in the manufacture of composites comprising cellulosic fibers, microcrystalline cellulose, nanocellulose, bioethanol, cellulosic derivatives and the like.

Further, with reference to FIG. 1, process 100 may further include step 112 of precipitating the treated lignocellulosic material under acidic conditions. In further embodiments of the present disclosure, step 112 may be performed at a temperature ranging from about 5° C. to about 90° C. In yet a further embodiment of the present disclosure, step 112 is performed at a temperature of about 30° C. In an embodiment of the present disclosure, step 112 is performed at a pH ranging from about 0.3 to about 4.0. In yet a further embodiment of the present disclosure, step 112 is performed at a pH ranging from about 1.0 to about 2.5. A person skilled in the art would understand that the processing conditions of step 112, including, for example, processing time, processing temperature and pH, can be varied to optimize the precipitation process and it is within their skill to do so. Following step 112, hemicelluloses (including, without limitation, furfural, C5 sugars, and the like) are separated and a highly pure lignin is obtained.

In an aspect, the present disclosure relates to a highly pure lignin as well as products and compositions comprising same. In an embodiment of the present disclosure, the lignin content of the highly pure lignin ranges from about 97% to about 99.9%. In a further embodiment of the present disclosure, the lignin content of the highly pure lignin ranges from about 97% to about 99%, wherein the highly pure lignin is characterized by substantially no sulfur content. In a further embodiment of the present disclosure, the lignin content of the highly pure lignin ranges from about 97% to about 99.9%, wherein the highly pure lignin is characterized by a low carbohydrate content. In a further embodiment of the present disclosure, the lignin content of the highly pure lignin ranges from about 97% to about 99.9%, wherein the highly pure lignin is characterized by a volatile organic content (VOC) of less than about 5%. In a further embodiment of the present disclosure, the lignin content of the highly pure lignin ranges from about 97% to about 99.9%, wherein the highly pure lignin is characterized by substantially no sulfur content and low carbohydrate content. In a further embodiment of the present disclosure, the lignin content of the highly pure lignin ranges from about 97% to about 99.9%, wherein the highly pure lignin is characterized by substantially no sulfur content, low carbohydrate content and a volatile organic content (VOC) of less than about 5%.

In a particular embodiment of the present disclosure, the lignin content of the highly pure lignin ranges from about 97% to about 99.9%, for example from about 97% to about 98%, for example from about 98% to about 99.9% or at any % or any range derivable therein. In yet further embodiments of the present disclosure, the highly pure lignin has a lignin content of about 99.9%, about 99.8%, about 99.7%, about 99.6%, about 99.5%, about 99.4%, about 99.3%, about 99.6%, about 99.5%, about 99.4%, about 99.3%, about 99.2%, about 99.1%, about 99.0%, about 98.9%, about 98.8%, about 98.7%, about 98.6%, about 98.5%, about 98.4%, about 98.3%, about 98.2%, about 98.1%, about 98.0%, about 97.9%, about 97.8%, about 97.7%, about 97.6%, about 97.5%, about 97.4%, about 97.3%, about 97.2%, about 97.1%, or about 97.0%.

In a particular embodiment of the present disclosure, the highly pure lignin is characterized by a low carbohydrate content, for example a carbohydrate content of about 1% or less than about 1%. In yet further embodiments of the present disclosure, the highly pure lignin has a carbohydrate content ranging from about 0% to about 1%, for example from about 0% to about 0.9%, for example from about 0% to about 0.8%, from example about 0% to about 0.7%, for example from about 0% to about 0.6%, for example from about 0% to about 0.5%, for example from about 0% to about 0.4%, for example from about 0% to about 0.3%, for example from about 0% to about 0.2%, for example from about 0 to about 0.1%, or at any % or any range derivable therein. In yet further embodiments of the present disclosure, the highly pure lignin has a carbohydrate content of about 1%, about 0.9%, about 0.8%, about 0.7%, about 0.6%, about 0.5%, about 0.4%, about 0.3%, about 0.2% or about 0.1%.

In a particular embodiment of the present disclosure, the highly pure lignin is characterized by a volatile organic content (VOC) of about 5.5% or less than about 5.5%. In yet further embodiments of the present disclosure, the highly pure lignin has a volatile organic content ranging from about 5.5% to about 3.0%, for example from about 5.0% to about 3.5%, for example from about 4.5% to about 4.0% or at any % or any range derivable therein. In yet further embodiments of the present disclosure, the highly pure lignin has a volatile organic content of about 5.5%, about 5.4%, about 5.3%, about 5.2%, about 5.1%, about 5.0%, about 4.9%, about 4.8%, about 4.7%, about 4.6%, about 4.5%, about 4.4%, about 4.3%, about 4.2%, about 4.1%, about 4.0%, about 4.0%, 3.9%, about 3.8%, about 3.7%, about 3.6%, about 3.5%, about 3.4%, about 3.3%, about 3.2%, about 3.1% or about 3.0%.

Generally during the organosolv process, lignin undergoes degradation by cleavage of ether linkages such as α-O-4 and β-O-4. Considering this and the fact that the β-O-4 linkages are the most abundant linkages occurring in lignin, lignin should undergo breakdown with the cleavage of these ether linkages.

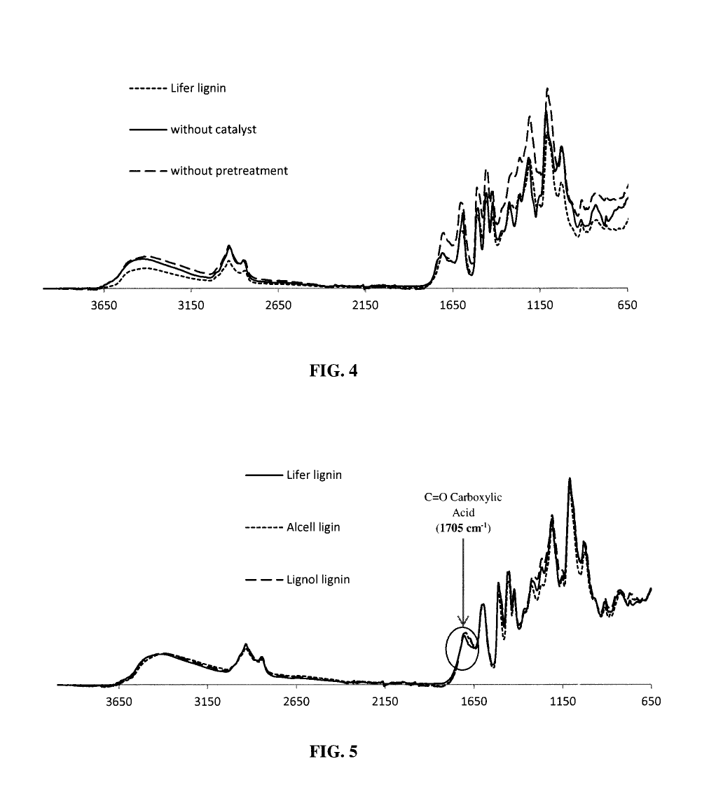

With reference to FIG. 4, the condensation index of lignin can be calculated such as proposed by Faix (Faix et al., Holz als Roh-und Werkstoff, 49, 9 (1991) p 356) using the following equation:

$$Condensation Index ( C I ) = \frac{Sum of all minima between 1500 and 1050 {cm}^{- 1}}{Sum of all maxima between 1600 and 1030 {cm}^{- 1}}$$

The condensation indices calculated show an index of 0.88 for lignin without pre-treatment, 0.86 for lignin without catalyst, and 0.70 for Lifer lignin. These results indicate that all stages of the organosolv process of the present disclosure contribute to obtain a highly pure lignin. The weak condensation index as obtained for Lifer lignin gives an assessment regarding the degree of degradation through secondary reactions that take place during delignification. A comparative study between lignin from different processes is presented in Table 1.

TABLE 1
Delignification without catalyst, with catalyst but
no extraction, with both catalyst and extraction.

| | Delignification | | |
|---|---|---|---|
| | Without Catalyst | With Catalyst | With catalyst |
| | (extracted wood | (non-extracted | (extracted wood |
| | particles) | wood particles) | particles: Lifer) |
| Yield (%), based | 13-15 | 16-18 | 17-19 |
| on oven dried | | | |
| (o.d.) wood | | | |
| Mw | 1296 | 1879 | 1663 |
| Mn | 679 | 737 | 599 |
| Tg (° C.) | 90 | 125-135 | 145-155 |

With reference to FIG. 5, Lifer lignin contains less condensed substructures with C—C bonds. However, the FT-IR spectra show that Lifer lignin contains less carboxylic acid functions (C═O acid around 1705 cm⁻¹) than other lignins, as already confirmed by ³¹P NMR experiments, indicative that the organosolv process of the present disclosure yields a less oxidized and therefore less degraded lignin than other organosolv processes. Moreover, the FT-IR spectrum of Lifer lignin shows that the relative intensity of the broad peak at 3424 cm⁻¹ decreased somewhat, which can likely be attributed to a lower carbohydrate content. Alcell and Lignol lignin contain a higher carbohydrate content and thus show a more intense signal. The aromatic skeletal vibrations around 1510 cm⁻¹ are attributed to bands of pure lignin, whereas the aromatic skeletal band around 1600 cm⁻¹ is a superimposed band that is broadened by the C═O stretching mode. Moreover, the weakened band associated with C═O stretching vibrations at 1705 cm⁻¹ confirmed that the oxidation and degradation of Lifer lignin was lower because of the effectiveness of the catalyst.

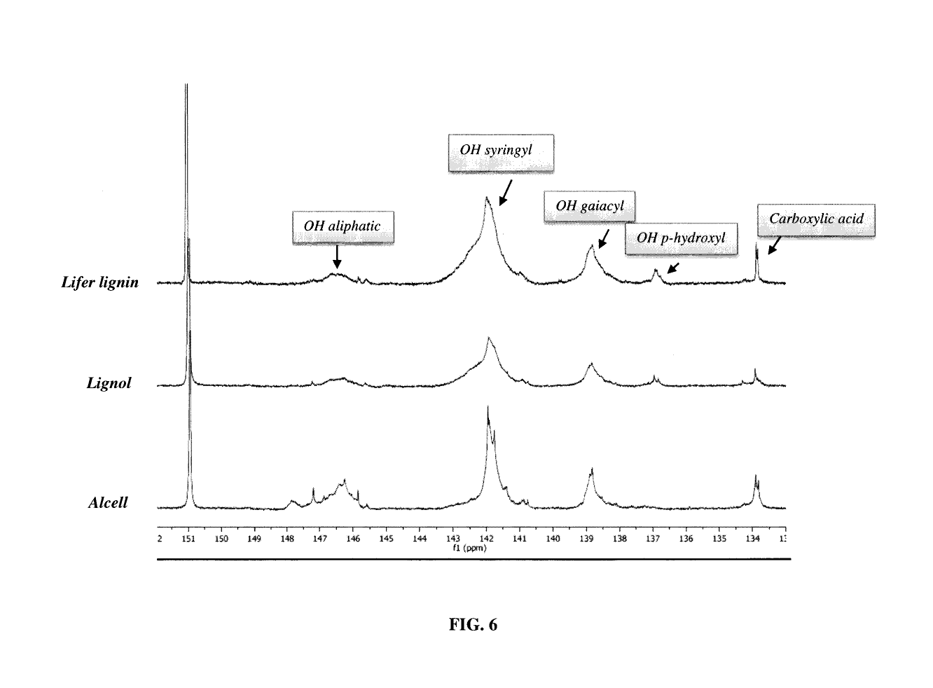

With reference to FIG. 6, and as further illustrated by the data presented in Table 2, higher values of phenolic OH in Lifer lignin (4.26 mmol/g), are indicative that the Lifer lignin has undergone less condensation reactions or radical polymerization reactions during the organosolv process of the present disclosure, as compared to other processes (e.g. Alcell and Lignol), implying that the phenols are more preserved in the presence of a Lewis acid catalyst (e.g. FeCl₃ catalyst). Furthermore, the lower values of carboxylic acid groups (0.11 mmol/g) in Lifer lignin are indicative that the Lifer lignin is more resistant to oxidation reactions which weaken and degrade lignins during pulping processes. Further with reference to FIG. 6, the ³¹P NMR analysis illustrates that Lifer lignin contains a higher amount of syringyl units when compared to either Lignol lignin or Alcell lignin.

TABLE 2
Py-GC/MS analyses of Aspen wood and Lifer lignin.

| Extractive-free Aspen wood | | | Lifer lignin | | |
|---|---|---|---|---|---|
| Name | Origin | % area | Name | Origin | % area |
| Phenol | H | — | Phenol | H | — |
| Gaiacol | G | 0.41 | Cresol | H | — |
| phenol, 2-methoxy-4-methyl | G | 0.89 | Gaiacol | G | 2.36 |
| 1,2-benzendiol | H | | 2-methoxy-5-methylphénol | G | 0.34 |
| 1,2-benzendiol, 3-methoxy | G | 0.53 | Cresol, 2-methoxy | G | 0.22 |
| phenol, 4-ethyl-2-methoxy | G | 0.18 | Phenol, 2-methoxy-4-methyl | G | 3.77 |
| 1,2-benzendiol, 3-methyl | H | — | 1,2-benzenediol | H | — |
| 2-methoxy-4-vinylphenol | G | 0.79 | 1,2-benzenediol, 3-methoxy | H | — |
| phenol, 2,6-dimethoxy | S | 1.33 | Phenol, 4-éthyl-2-methoxy | G | 2.83 |
| phenol, 2-methoxy-3-(2-propenyl) | G | 0.18 | 1,2-benzendiol, 4-methyl | H | — |
| phenol, 3,4-dimethoxy | S | 0.16 | 2-methoxy-4-vinylphenol | G | 1.04 |
| Vanillin | G | 0.37 | 3-methoxy-5-methylphénol | G | 1.20 |
| Isoeugenol | G | 0.20 | phenol, 2,6-dimethoxy | S | 0.50 |
| benzoic acid, 4-hydroxy-3-methoxy | G | 1.12 | phenol, 2,6-dimethoxy | S | 0.49 |
| Eugenol | G | 0.64 | phenol, 2-methoxy-3-(2-propenyl) | G | 5.00 |
| phenol, 2-methoxy-4-propyl | G | 0.23 | phenol, 3,4-dimethoxy | S | 0.43 |
| Benzoic acid, 4-hydroxy | H | — | Euganol | G | 1.02 |
| acetovanillone | G | 0.24 | Phenol, 4-methoxy-3-(methoxymethyl) | G | 0.39 |
| phenol, 4-methoxy-2,3,6-trimethyl | G | 0.16 | Vanillin | G | 0.65 |
| 3-tert-butyl-4-hydroxyanisole | G | 2.61 | Isoeugenol | G | 1.08 |
| 2-propenoic acid, 3-(4-hydroxy-3-methoxyphenyl) | G | 0.78 | 3,4-dihydroxy-5-methoxybenzaldehyde | G | 0.23 |
| 3-hydroxy-4-methoxycinnamic acid | G | 0.42 | Phenol, 2-methoxy-4-(1-propenyl) | G | 6.88 |
| benzaldehyde, 4-hydroxy-3,5-dimethoxy | S | 0.95 | Homovanillyl alcohol | G | 0.97 |
| 4-(1E)-3-hydroxy-1-propenyl)-2-methoxyphenol | G | 0.15 | Methylparaben | H | — |
| 3-buten-2-one, 4-(4-hydroxy-3-methoxyphenyl) | G | 0.27 | Acetovanillone | G | 0.22 |
| benzaldehyde, 3-hydroxy-4-methoxy-2(2-propenyl) | G | 0.18 | 3,4-dimethoxy-5-hydroxybenzaldehyde | S | 1.17 |
| phenol, 2,6-dimethoxy-4-(2-propenyl) | S | 1.97 | benzoic acid, 4-hydroxy-3-methoxy, methyl ester | G | 0.64 |
| Ethanone, 1-(2-hydroxy-4,6-dimethoxyphenyl) | S | 0.51 | Ethanone, 1-(2,6-dihydroxy-4-methoxyphenyl) | G | 0.17 |
| 4-hydroxy-2-methoxycinnamaldehyde | G | 0.48 | 2-propanone, 1-(4-hydroxy-3-methoxyphenyl) | G | 1.56 |
| Coniferyl alcohol | G | 1.42 | Ethylparaben | H | — |
| Desaspidinol | G | 0.61 | Benzoic acid, 4-hydroxy | H | — |
| Ethanone, 1-(4-hydroxy-3,5-dimethoxyphenyl) | S | 0.27 | 2,4′-dihydroxy-3′-methoxyacetophenone | G | 1.04 |
| 3,5-dimethoxy-4-hydroxyphenylacetic acid | S | 0.19 | 1-propanone-3-hydroxy-1-(4-hydroxy-3-methoxyphenyl) | G | 0.31 |
| Benzoic acid, 2-hydroxy-4-methoxy-3,5,6-trimethyl | G | 0.52 | Phenol, 2,6-dimethoxy-4-(2-propenyl) | S | 1.32 |
| | | | 3,5-dimethoxy-4-hydroxyphenyl acetic acid | S | 0.67 |
| | | | Phenol, 2,6-dimethoxy-4-(2-propenyl) | S | 0.58 |
| | | | Benzaldehyde, 4-hydroxy-3,5-dimethoxy | S | 0.67 |
| | | | 3-buten-2-one, 4-(4-hydroxy-3-methoxyphenyl) | S | 2.26 |
| | | | benzaldehyde, 3-hydroxy-4-methoxy-2-(2-propenyl) | G | 0.53 |
| | | | Phenol, 2,6-dimethoxy-4-(2-propenyl) | S | 0.64 |
| | | | Ethanone, 1-(4-hydroxy-3,5-dimethoxyphenyl) | S | 2.10 |
| | | | 4-hydroxy-2-methoxycinnamaldehyde | G | 2.13 |
| | | | | | 0.07 |
| | | | Desaspidinol | G | 1.45 |
| | | | Ethanone, 1-(4-hydroxy-3,5-dimethoxyphenyl) | S | 1.77 |
| | | | 3,5-dimethoxy-4-hydroxyphenyl acetic acid | S | 0.32 |

H = p-Hydroxyls units; G = Guaiacyls units and S = Syringyls units.

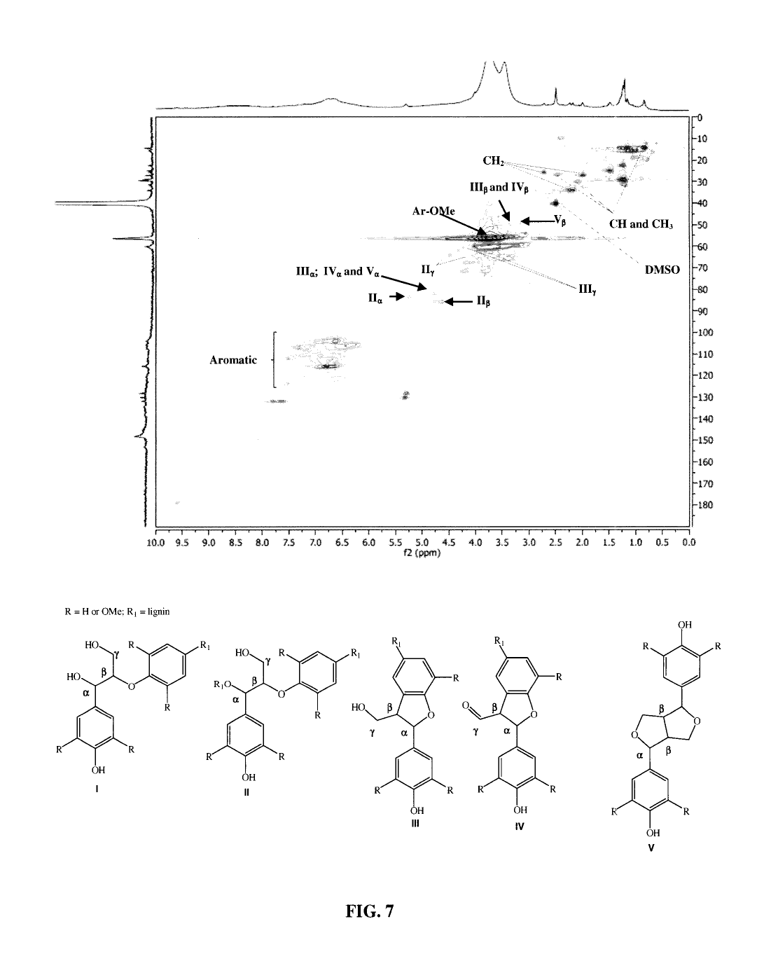

With reference to FIG. 7, the NMR studies confirm that Lifer lignin comprises the major β-O-4, β-13, β-5, β-1 linkages. Moreover, various lignin units can be assigned by HSQC NMR analysis. Furthermore, the β-O-4 substructure, the most important substructure in all lignins, remains in Lifer lignin in the form of its native aliphatic OH. The HSQC experiments further revealed that correlations due to the β-O-4 ether linkages increased significantly, in particularly with lignin model type II (FIG. 7). Indeed, according to the signal intensity of lignin model type II, the β-O-aryl bond showed that there is no free-aliphatic OH in the α-position. Thus the absence of free-aliphatic OH functionalities in the α-position of the β-O-4 moieties confirms that the Lifer lignin leads to lignin with high grade purity.

The pretreatment of the lignocellulosic material or biomass in a polar protic solvent removes extractive compounds from the structural matrix of the lignocellulosic material or biomass. This pretreatment step thus contributes in the organosolv process of the present disclosure to the extracting of a highly pure lignin in its natural form. The organosolv process of the present disclosure delignifies a lignocellulosic material or other biomass (such as wood and crop material) by using a Lewis acid catalyst as a phenol complexing agent. In an embodiment of the present disclosure, the Lewis acid contributes to the protection of the original or native structure of lignin. Accordingly, in an aspect, the organosolv process of the present disclosure yields a much less degraded lignin product (as confirmed by the small condensation index) and a higher purity lignin (high Klason lignin content, small residual sugars content, and the like) than other organosolv lignins (such as Alcell or Lignol lignins). DSC thermal analysis revealed a high Tg (ranging between 140° C. and 155° C.) which is indicative of the higher thermal properties of the lignin product. Indeed, the results obtained by DSC corroborate the higher grade purity as ascertained by both the ³¹P and HSQC NMR analysis experiments.

In an aspect, the present disclosure relates to a highly pure lignin as well as to uses thereof. In an embodiment, the present disclosure relates to the use of the highly pure lignin in the manufacture of composites as well as nanofibers. In further embodiments of the present disclosure, the highly pure lignin is used in the manufacture of vanillin and other chemicals, adhesives and resins as well as various composite materials and coatings.

### EXPERIMENTAL

A number of examples are provided herein below illustrating the organosolv process in accordance with various embodiments of the present disclosure. The following non-limiting examples are illustrative of the present disclosure.

### Example 1: Raw Materials

Aspen wood (Populus tremuloides Michx) was used in the organosolv process described herein. After being debarked and air dried, the wood particles were ground. The main chemical constituents are summarized in Table 3.

TABLE 3
Aspen raw material characterization

| | With extraction |
|---|---|
| Main constituents of Aspen wood | (% of dry weight) |
| Ethanol/water extractives (maceration) | 3.1 ± 0.2 |
| Klason lignin | 16.4 ± 2.2 |
| Acid soluble lignin | 4.2 ± 0.2 |
| Total lignin | 20.6 ± 2.4 |
| Glucose | 53.1 ± 0.7 |
| Xylose | 19.70 ± 0.03 |

### Example 2: Organosolv Process for the Extraction of Highly Pure Lignin from Aspen Wood

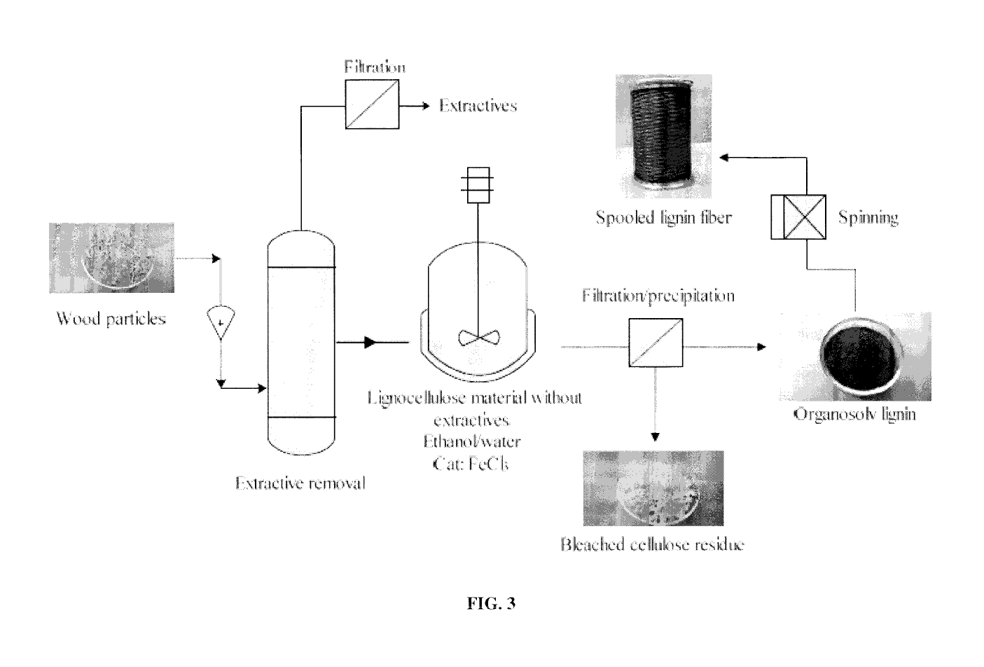

With reference to FIGS. 1 and 3, prior to organosolv pulping, the wood particles was first pretreated with an ethanol-water mixture (1:1, v/v; 1 L of final volume mixture for 100 g of wood), which was subsequently heated to reflux in a Soxhlet extractor for 6 hours to remove extractives. The extracted product was then treated again with an ethanol-water mixture (1:1, v/v; 0.5 L of final volume mixture for 100 g of wood particles) in a Parr reactor in the presence of Iron III (Fe³⁺) catalyst as the phenol complexing agent over a period of 1 hour at 170° C.-180° C. (0.5-7 g of FeCl₃.6H₂O for 100 g of wood particles). The biomass thus fractionated was then filtered to remove dissolved hemicelluloses and the precipitation of lignin was then performed in an acidic solution.

### Example 3: Determination of Klason Lignin Content and Carboyhdrate Analysis

Klason and acid soluble lignins were analyzed according to National Renewable Energy Laboratory methodology NREL/TP-510-42618 (Determination of Structural Carbohydrates and Lignin in Biomass). Carbohydrate analyses of the samples were carried out in triplicate following the NREL methodology, so as to quantify the monosaccharides by HPLC-RID, using an Agilent Technologies™ 1200 Series equipped with a Rezex™ RHM-Monosaccharide H+8% (300×7.8 mm) column. Elution with deionized water at 0.5 mL/min was performed for 20 min. The standard calibration curve was obtained with pure standards of cellobiose, glucose, xylose, mannose and arabinose (Sigma-Aldrich™). The identification and quantification of sugars were performed uisng the retention times (RT) with injection at four points of different concentrations of the chromatographic grade standards. Selected properties for several lignins are illustrated in Table 4.

TABLE 4
Selected properties for several lignins as determined
in accordance with ORNL specifications.

| | | Lifer | Alcell | Lignol | |
|---|---|---|---|---|---|
| Caracterisation | Specifications | lignin | lignin | lignin | References |
| Klason lignin (%) | N/A | 94.3 ± 0.7 | 89.7 ± 2.1 | 90.4 ± 0.5 | ASTM D 1106 |
| Acid soluble | N/A | 3.8 ± 0.3 | 5.4 ± 0.4 | 4.2 ± 0.3 | ASTM D 1106 |
| lignin (%) | | | | | |
| Lignin | ≥99 | 98.1 ± 1.0 | 95.1 ± 2.5 | 94.6 ± 0.8 | ASTM D 1106 |
| content(%) | | | | | |
| Carbohydrate | <500 ppm | 0.0 | 3.58 ± 0.1 | 3.06 ± 0.02 | NREL 2012 |
| Content (%) | | | | | Carbohydrates |
| Ash content (%) | <0.1 | 0.25 ± 0.04 | 0.08 ± 0.01 | 1.4 | ASTM D 1102-84 |
| | (at 900° C.) | (at 600° C.) | (at 900° C.) | (at 600° C.) | (600° C.) |
| | | | | | Tappi T-413 |
| | | | | | (900° C.) |
| Free phenolic | N/A | 4.26 | 3.34 | 3.11 | ³¹P NMR |
| hydroxyl content | | | | | |
| (mmol/g) | | | | | |
| Volatile material | <5% | 4.2 ± 0.9 | 9.4 ± 1.43 | 7.4 ± 0.3 | ORNL |
| (%) | (250° C.) | | | | standards |

### Example 4: FT-IR Analysis

Normalized FT-IR spectra were obtained for each sample using a Fourier transform infrared spectrometer (ATR-FT-IR/FT-NIR PerkinElmer™ Spectrum 400). Selected assignments are illustrated in Table 5. The FTIR spectra, were recovered for 64 scans and collected for wave numbers ranging from 4000 to 650 cm⁻¹.

TABLE 5
FT-IR analyses and assignments

| Wavenumber | | Lifer |
|---|---|---|
| (cm⁻¹) | Assignments | lignin |
| 1709-1738 | C═O (unconjugated ketones, aldehydes, | 1705 |
| | esters and carboxylic acid) | |
| 1655-1675 | C═O (conjugated ketones) | — |
| 1593-1605 | Aromatic skeletal plus C═O stretch; | 1598 |
| | S > G; G condensed > G etherified | |
| 1505-1515 | Aromatic skeletal; G > S | 1513 |
| 1460-1470 | C—H deformations | 1457 |
| 1422-1430 | Aromatic skeletal plus C—H in plane | 1422 |
| | deformation | |
| | Aliphatic C—H | |
| 1365-1370 | S ring plus G ring condensed | 1369 |
| 1325-1330 | G ring plus C═O | 1317 |
| 1266-1270 | C—C plus C—O plus C═O; | 1268 |
| 1221-1230 | G condensed > G etherified | 1211 |
| | HGS lignin; C═O esters (conj.) | |
| 1216 | Aromatic C—H in plane deformation; | 1152 |
| 1140 | G condensed > G etherified | |
| | Aromatic C—H in plane deformation; | |
| 1128-1125 | G condensed > G etherified | 1110 |
| 1086 | C—O deformation (secondary alcohol | — |
| | and aliphatic ethers) | |
| 1030-1035 | Aromatic C—H in plane deform; G > S; | 1025 |
| | C—O; primary alcohol; C═O (unconj.) | |
| | —HC═CH— out of plane (trans) | |
| 966-990 | C—H out of plane; aromatic | 962 |
| 915-925 | C—H out of plane; G units | 906 |

### Example 5: NMR Analyses

¹H, ¹³C NMR and HSQC spectra were recorded on a Bruker™ NMR spectrometer at 500 MHz using solutions obtained by dissolving 60 mg of lignin in 0.5 mL of DMSO-d₆. Data processing was performed using standard Bruker™ Topspin-NMR™ software. Quantitative ³¹P NMR was used and ³¹P NMR spectra were recorded on a Bruker™ NMR spectrometer at 500 MHz by dissolving 40-45 mg of dried lignin in 0.5 mL of anhydrous pyridine/CDCl₃ mixture (1.6/1, v/v). A total of 0.1 mg of endo-N-hydroxy-5-norbornene-2,3-dicarboximide for each mg of lignin was added as the internal standard, and 0.06 mg of a chromium(III) acetylacetonate for each mg of lignin was added as the relaxation reagent. Finally, 150 μL of 2-chloro-4,4,5,5-tetramethyl-1,2,3-dioxaphospholane was added as the phosphotylating reagent and transferred into a 5-mm NMR tube for NMR analysis.

### Example 6: Thermal Analyses

Thermogravimetric analyses of lignin were performed following the procedure described by Chatterjee et al. (Chatterjee, S. et al., RSC Adv., 2014, 4, 4743-4753). Thermogravimetric analysis of lignin was conducted under air from 25° C. to 250° C. and then by carbonization from 25° C. to 800-1000° C. under nitrogen. Lignin was heated to 250° C. at a rate of 10° C./min under air. The sample was then maintained at 250° C. for 30 min. This allows for stabilization and oxidation of lignin. The sample was then cooled to 25° C. and heated to 800-1000° C. at a rate of 5° C./min under a nitrogen atmosphere for carbonization. The sample was then maintained at 800-1000° C. for 30 min.

### Example 7: Pyrolysis-GC/MS Analysis

Pyrolysis-GC/MS of the studied samples was performed using a filament pulse pyrolyser (Pyro-Prob™ 2000 CDS Analytica™ 1 Inc) coupled to a GC-MS system. The GC-MS consists of a gas chromatograph from Varian™ (CP 3800) coupled with a mass spectrometer from Varian Saturn™ 2200 (MS/MS, 330-650 uma). An amount of 0.4 mg of sample was dried during 30 seconds at 100° C. The temperature of the pyrolyser transfer line and the GC injector were both set at 250° C. The sample was pyrolyzed according to the following program: the transfer line temperature was maintained during 10 seconds and then increased to 550° C. at a rate 20° C./s and held for 10 seconds. Helium was used as the vector gas. A VF-5 ms capillary column was used. The oven temperature program was 45° C. for 1 min and then increased to the final temperature of 250° C. at a rate of 5° C. min⁻¹ and held for 5 min. The mass spectrometer was operated in electron impact mode (EI, 70 eV, m/z=35-400) at 1 second per scan. There were three repetitions for each sample examined. Each chromatogram peak was identified with the National Institute of Standards and Technology (NIST) Mass Spectral Library.

### Example 8—³¹P NMR Experiments

As shown in FIG. 6, two distinct broad signals appear in the phenolic region of the ³¹P NMR spectra, as evidenced by the signals at 138 and 144 ppm. In the Lifer lignin spectrum, the broad peak at around 142 ppm was attributed to the syringyl unit, while the peak at 138 ppm was attributed to the hydroxyl groups originally present in gaiacyl units. Selected data for Lifer lignin, Lignol lignin and Alcell lignin are illustrated in Table 6. The high level of phenol content from Lifer lignin (syringyl and gaiacyl units) was attributed to the effectiveness of the catalyst which protects the phenol moieties against the degradation process of the β-O-4 unit (Scheme 1).

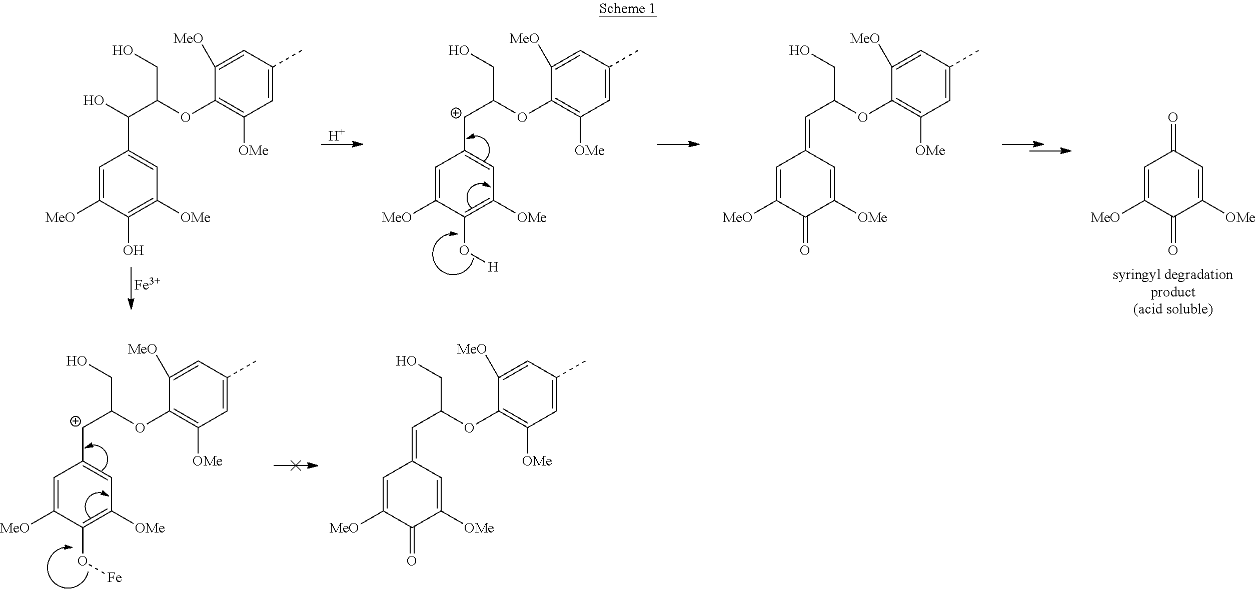

TABLE 6
³¹P NMR experiments

| | Lifer Lignin | | | Lignol Lignin | | | Alcell Lignin | | |
|---|---|---|---|---|---|---|---|---|---|
| | | OH | | | OH | | | OH | |
| | | mole | | | mole | | | mole | |
| | | number | ε OH | | Number | ε OH | | Number | ε OH |
| Assignment | Integration | (mmol) | (mmol/g) | Integration | (mmol) | (mmol/g) | integration | (mmol) | (mmol/g) |
| Standard (e-NHI) | 1.000 | 0.025 | / | 1.000 | 0.025 | / | 1.000 | 0.025 | / |
| Aliphatic | 1.62 | 0.040 | 0.90 | 1.71 | 0.043 | 0.994 | 2.61 | 0.065 | 1.45 |
| Syringyls | 5.27 | 0.131 | 2.930 | 3.25 | 0.081 | 1.889 | 3.40 | 0.085 | 1.88 |
| condensed unit | — | — | — | 0.19 | 0.0047 | 0.110 | 0.46 | 0.011 | 0.255 |
| Guaiacyls | 2.06 | 0.050 | 1.14 | 1.51 | 0.038 | 0.878 | 2.01 | 0.05 | 1.12 |
| p-Hydroxyphenyl | 0.34 | 0.0085 | 0.19 | 0.41 | 0.010 | 0.238 | 0.16 | 0.004 | 0.088 |
| Carboxylic acid | 0.20 | 0.005 | 0.11 | 0.40 | 0.010 | 0.233 | 0.64 | 0.016 | 0.355 |
| OH phenolic | 5.29 | 0.189 | 4.26 | 1.727 | 0.0431 | 3.115 | 6.03 | 0.15 | 3.343 |
| total OH | 8.27 | 0.207 | 5.27 | 6.315 | 0.1576 | 4.342 | 9.28 | 0.231 | 5.148 |

### Example 9—PY-GC/MS Experiments

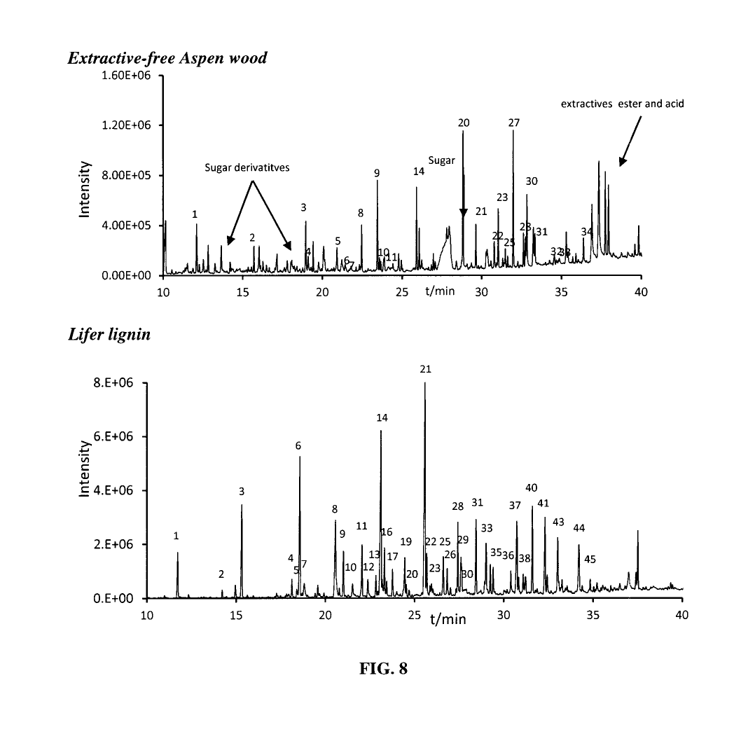

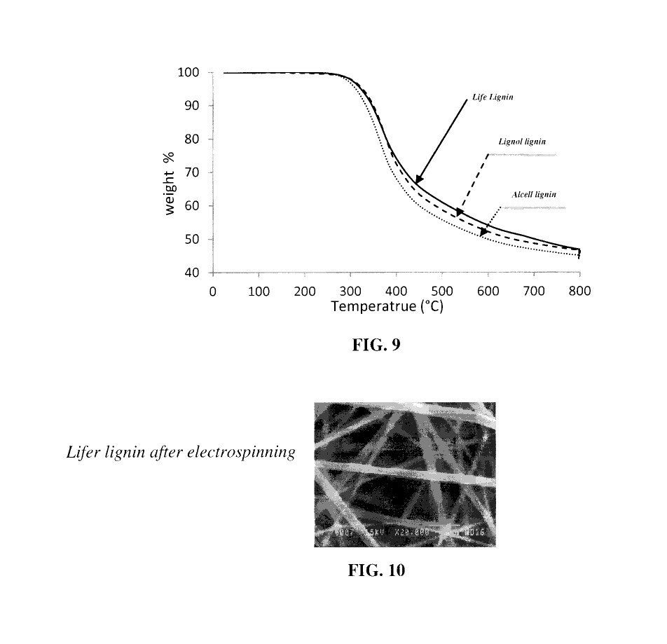

The results of the Py-GC/MS analysis of original Aspen wood and Lifer lignin are presented in FIG. 8 and Table 3. The production of p-hydroxy-benzoic acid (benzoic acid, 4-hydroxy), both by pyrolysis of original Aspen wood and by Lifer lignin, confirms its recovery at the alpha position in Lifer lignin, as previously confirmed by HSQC NMR studies.

### Example 10: DSC Analysis—Application for Carbon Fiber and Polymers Composites

The glass transition temperature (Tg) of lignin determines the conditions required in the melt spinning process for its conversion into carbon fibers. Indeed, since lignin loses plasticity when cooled, particularly below the glass transition temperature, the likelihood of fracture during drawing or winding may increase. Thus, in order to maintain the plastic properties of lignin during extrusion, many studies have focused on increasing the glass transition temperature of lignins. Chang and co-workers (WO 2014/046826) have previously shown that the glass transition temperature could be increased from 100° C. to 134° C. by heating the lignin at 250° C. under nitrogen before spinning. Baker & co-workers (US 2014/0271443) have previously shown that sequential extractions of lignin using water, methanol and dichloromethane, with drying at 80° C. for 24 hours between extractions, provided a lignin having a glass transition temperature of 155° C. The organosolv process of the present disclosure provides for increasing the glass transition temperature of Lifer lignin to values ranging between 147° C. and 155° C. (Table 7). The Lifer lignin as obtained by the organosolv process of the present disclosure exhibited enhanced thermal properties as illustrated by DSC and TGA analyses. During the TGA analysis under nitrogen, the first degradation of lignin was observed at 217° C. whereas, the thermal degradation of Alcell and Lignol lignins started at 216° C. and 192° C. respectively. The temperature corresponding to a 50% weight loss for Lifer lignin (during carbonization) was observed at approximatively 700° C., whereas the temperatures corresponding to thermal degradation leading to 50% weight loss for Alcell and Lignol lignins were observed at approximately 600° C. and 645° C. respectively. Without wishing to be bound by theory, it is surmised that the enhanced thermal properties of Lifer lignin are at least in part due to its higher phenol content.

TABLE 7
DSC and TGA analysis for Lifer lignin,
Alcell lignin and Lignol lignin.

| | Lifer | Alcell | Lignol |
|---|---|---|---|
| Analyses | lignin | Lignin | Lignin |
| DSC, Tg (° C.) | 145-155 | 90-97 | 126-130 |
| T° of first degradation in | 217 | 216 | 192 |
| TGA, under N₂ (° C.) | | | |
| T° at 50% of weight loss | 700 | 600 | 645 |
| in TGA under N₂ (° C.) | | | |

While the present disclosure has been described with reference to what are presently considered to be the preferred examples, it is to be understood that the disclosure is not limited to the disclosed examples. To the contrary, the disclosure is intended to cover various modifications and equivalent arrangements included within the spirit and scope of the appended claims.

1. An organosolv process for extracting highly pure lignin from a lignocellulosic material, the process comprising:
pretreating the lignocellulosic material in a first polar protic solvent, to remove extractive compounds and to provide a pretreated lignocellulosic material; and
treating the pretreated lignocellulosic material with a Lewis acid in a second polar protic solvent, to provide a highly pure lignin.

2. The process of claim 1, wherein the first polar protic solvent is at least one of CH₃COOH, HCOOH, H₂O, CH₃OH, EtOH, iPrOH, PrOH, BuOH, iBuOH or tBuOH or combinations of any thereof.

3. The process of claim 1, wherein the second polar protic solvent is at least one of CH₃COOH, HCOOH, H₂O, CH₃OH, EtOH, iPrOH, PrOH, BuOH, iBuOH or tBuOH or combinations of any thereof.

4. The process of claim 1, wherein the first polar protic solvent is a mixture of polar protic solvents.

5. The process of claim 4, wherein the mixture of polar protic solvents includes a ratio of about 1:10 to about 10:1 of two polar protic solvents.

6. (canceled)

7. (canceled)

8. The process of claim 1, wherein the second polar protic solvent is a mixture of polar protic solvents.

9. The process of claim 8, wherein the mixture of polar protic solvents includes a ratio of about 1:10 to about 10:1 of two polar protic solvents.

10. (canceled)

11. (canceled)

12. The process of claim 1, wherein the Lewis acid is at least one of Cu²⁺, Fe²⁺, Fe³⁺, Al³⁺, Ga³⁺, BF₃, Bi³⁺, Sc³⁺, La³⁺, Yb³⁺ or In³⁺ or combinations of any thereof.

13. (canceled)

14. The process of claim 1, wherein the pretreating the lignocellulosic material is performed at a temperature ranging from about 60° C. to about 100° C.

15. The process of claim 1, wherein the treating the pretreated lignocellulosic material comprises precipitating the treated lignocellulosic material under acidic conditions.

16. The process of claim 15, wherein the precipitating is performed at a pH ranging from about 0.3 to about 4.0.

17. (canceled)

18. The process of claim 1, wherein the lignocellulosic material is at least one of herbaceous biomass, softwood, hardwood or combinations thereof.

19. A highly pure lignin comprising a lignin content of at least 97%.

20. The highly pure lignin of claim 19, wherein the highly pure lignin comprises a lignin content ranging from about 97% to about 99.9%.

21. The highly pure lignin of claim 19, wherein the highly pure lignin is characterized by a carbohydrate content of less than about 1%.

22. (canceled)

23. The highly pure lignin of claim 19, wherein the highly pure lignin is further characterized by a low ash content.

24. The highly pure lignin of claim 19, wherein the highly pure lignin is further characterized by substantially no sulfur content.

25. The highly pure lignin of claim 19, wherein the highly pure lignin is characterized by a volatile organic content (VOC) of less than about 5%.

26. The highly pure lignin of claim 19, wherein the highly pure lignin is characterized by a phenolic OH content of at least 4.00 mmol/g.

27. An organosolv process for the separation of a highly pure lignin from a lignocellulosic material, wherein the highly pure lignin comprises a lignin content of at least 97%, the organosolv process comprising:
pretreating the lignocellulosic material in a first polar protic solvent, to remove extractive compounds and to provide a pretreated lignocellulosic material; and
treating the pretreated lignocellulosic material with a Lewis acid in a second polar protic solvent, to provide a highly pure lignin.

28-43. (canceled)
